(19) United States
(12) Patent Application Publication
(10) Pub. No.: US 2006/0187912 A1
(43) Pub. Date: Aug. 24, 2006

(54) Method and apparatus for server-side NAT detection

(75) Inventors: David Schwartz, Ginot Shomron (IL); Baruch Sterman, Passaic, NJ (US)

Correspondence Address: PEARL COHEN ZEDEK, LLP, 1500 BROADWAY 12TH FLOOR, NEW YORK, NY, 10036, US

(73) Assignee: KAYOTE NETWORKS INC.

(21) Appl. No.: 11/046,824

(22) Filed: Feb. 1, 2005

(51) Int. Cl. H04L 12/56

(52) U.S. Cl. 370/389

(57) ABSTRACT

A method and system for a server side detection of a Network Address Translation (NAT) device is provided. During the server-side NAT determination process, the client device is not required to have knowledge of the type of NAT device that the client device is behind. The server side NAT determination process may include comparing between the address information that is embedded by the client device and address information as obtained by units within the server-side NAT detection device.

### BACKGROUND OF THE INVENTION

A Network Address Translation (NAT) device converts or maps internal IP addresses and port numbers in a private network to external IP addresses and ports in a public network, during data transfer between private and public networks. This allows for a limited number of private IP addresses to serve a larger number of public IP addresses.

Two-way IP-based voice and multimedia communication with client devices, located behind a NAT device, however, is not a straightforward task. Voice over IP (VoIP) signaling protocols, such as SIP protocol used by the client devices, insert the private address information within the data portion of the protocol packet. The problem is that the inserted private address information is not routable in public networks and when a public device attempts to transmit back to the private address, the data would not reach its destination.

There exist several methods to traverse a NAT, including Universal Plug and Play (UPnP), Simple Traversal of UDP Through NATs (STUN), Connection Oriented Media, Traversal Using Relay NAT (TURN), and RTP-Relay (Real Time Protocol Relay). Each of these methods is best suited for specific types of NAT devices. More specifically, UPnP and STUN are tailored to Full Cone, Restricted Cone, or Port Restricted Cone NAT types while Connected Oriented Media and RTP-Relay methods are tailored to Symmetric NAT devices. Therefore, in order to implement the aforementioned methods or similar methods for delivering data to a client behind a NAT device, there is a need to determine the type of NAT device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic view of a network environment in accordance with exemplary embodiments of the invention;

FIGS. 2A and 2B are block diagrams of an exemplary network including a NAT detection device according to some embodiments of the invention;

FIGS. 3A and 3B are flowchart diagrams demonstrating method of server-side NAT detection according to some embodiments of the invention;

FIGS. 4A and 4B are block diagrams of an exemplary network including a NAT detection device according to some embodiments of the invention; and

FIGS. 5A and 5B are diagrams demonstrating a method of server-side NAT detection according to some embodiments of the invention.

It will be appreciated that for simplicity and clarity of illustration, elements shown in the figures have not necessarily been drawn to scale. For example, the dimensions of some of the elements may be exaggerated relative to other elements for clarity Further, where considered appropriate, reference numerals may be repeated among the figures to indicate corresponding or analogous elements

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

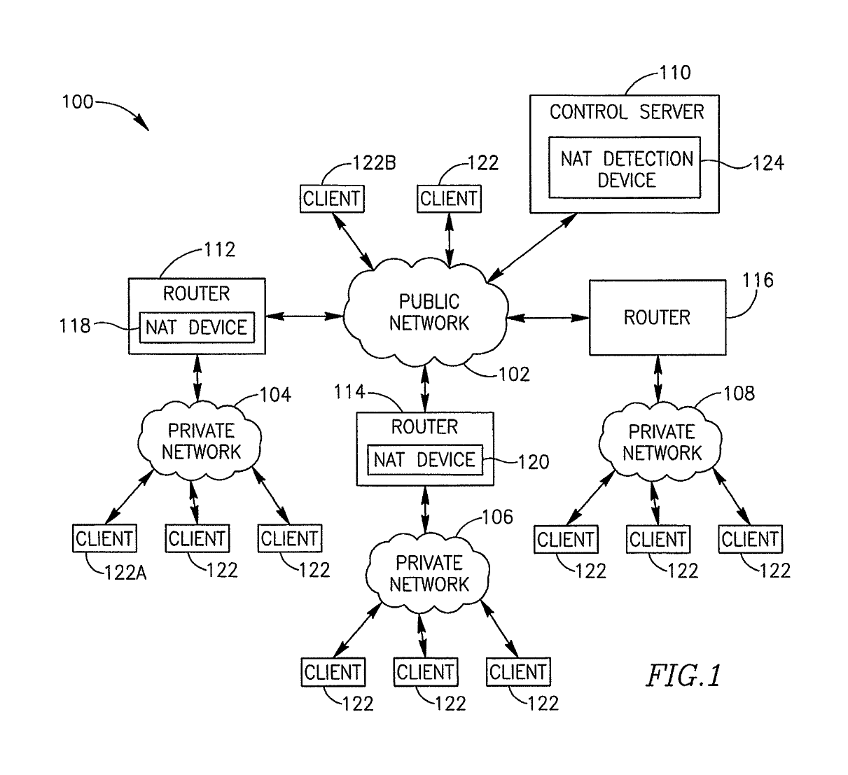

FIG. 1 contains a block diagram of an exemplary embodiment of a communications network environment 100 including a public network 102, private networks 104, 106, 108 and a control server 110 according to some embodiments of the present invention. The communications network may be configured to carry data using ATM, IP, TCP, UDP, or RTP protocols, any combination thereof, and any other suitable methodology. Private networks 104, 106 and 108 may be coupled to public network 102 via routers 112, 114 and 116 respectively. Routers 112 and 114 may comprise NAT devices 118 and 120, respectively, such as, for example, a fill cone NAT device, a restricted cone NAT device a port restricted cone NAT device and a symmetric NAT device whereas router 116 may not have NAT capabilities.

IP-based client devices 122 may be coupled to each of networks 102, 104, 106, and 108. Devices 122 may include IP telephones, videoconference stations, personal computers, personal digital assistants, and others. Devices 122 may operate according to VoIP protocols, such as, for example, sessions initiated protocol (SIP), MGCP protocol, and H.323 standard protocol. It should be understood, however to a person skilled in the art that other VoIP might be implemented according to other embodiments of the present invention.

Control server 110, which provides call-control services for IP-based client devices 122, may comprise a NAT detection device 124. Alternatively, the NAT detection device may be embedded in another server (not shown) coupled to public network 102 and control server 110.

In order for a two-way communication between for example, an IP phone 122A coupled to private network 104 and an IP phone 122B coupled to public network 102 to occur, the external IP address and port that NAT device 118 selects for signaling and media flow should be determined. As explained above, in order to implement the existing methods for determining the public address information, there is a need to determine first the type of NAT device that the data has to traverse.

Some IP-based client devices are capable of discovering if they are behind a NAT device and if so the specific type of NAT device in order to determine the external IP address and port that the NAT device selects for signaling and media flow. According to embodiments of the present invention, the end devices may not be aware of their NAT status as the NAT type discovery process is being executed on the server side. In a server-based discovery the public address information may not need to be relayed back to the client device. Throughout the specification and claims, the terms “address information” and “IP address” refer to the IP and port.

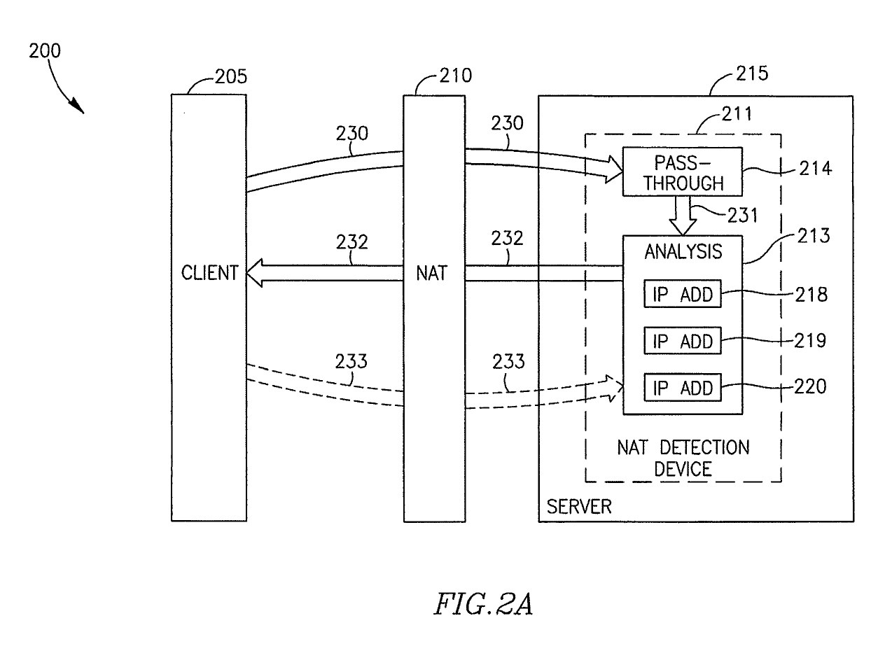

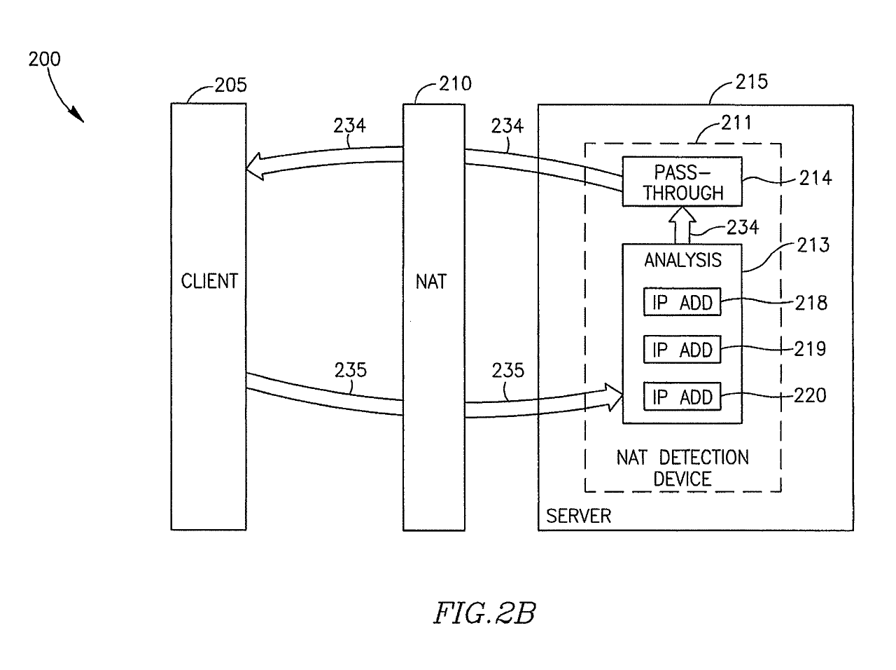

FIG. 2A is block diagram of an exemplary network 200 that includes a passive server-side NAT detection device according to some embodiments of the present invention Network 200 may comprise client (IP-based client device) 205 behind a NAT device 210 and a server 215 Server 215 may comprise a server-side NAT detection device 211 having a pass-through unit 214 and an analysis unit 213. Pass-through unit 214 may be the first unit receiving the downstream signaling path from NAT device 210.

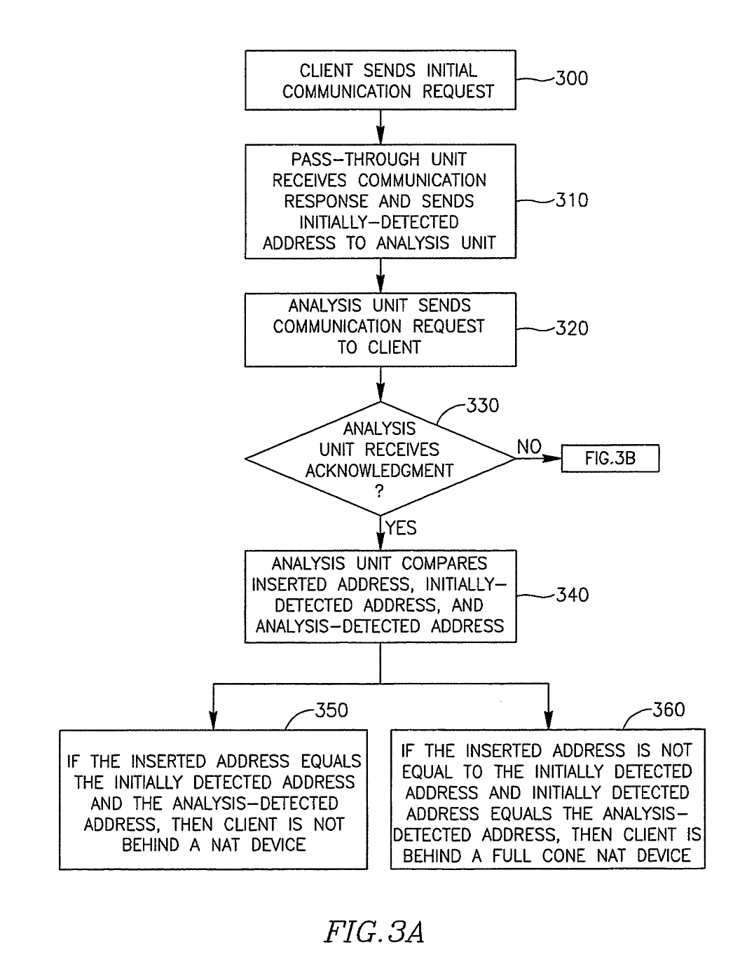

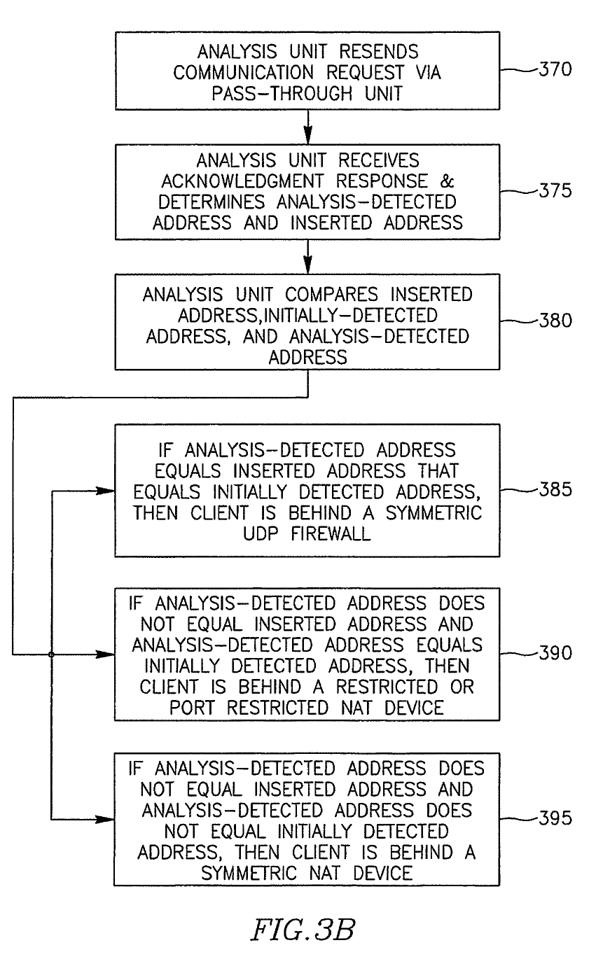

Additional reference is made to FIG. 3A, which is a flowchart diagram describing a method for passively detecting the type of NAT device that enables two way communication between end users, according to embodiments of the present invention. The exemplary embodiment below describes an implementation of server-side NAT detection for a SIP signaling protocol. It should be understood to persons skilled in the art that the invention is equally applicable for other IP protocols.

At block 300, client 205 may initiate communication with another end user (not shown) by sending an initial communication request (INVITE) 230 to pass-through server 214. The packet included within signaling request 230 contains the IP address information as inserted by the client 205. The received IP address information is designated as inserted address 218. The actual IP address information that pass-through server 214 initially detects is the public address and port that was assigned to the private address and port by NAT device 210, designated as initially detected address 219.

Throughout the specification and claims, the term “inserted address” refers to the IP address information received from the client 205 within the SIP signaling and the term “initially detected address” refers to the IP address information as detected by the pass-through unit 214.

At block 310, pass-through unit 214 may add to request 230, a tag with the initially detected address 219 and may send a revised request 231 to analysis server 213. It should be noted that analysis unit 213 additionally receives the inserted address 218 that is embedded within revised request 231.

At block 320, analysis unit 213 may send a communication message 232, embedded with its own IP address and port, directly to the IP address of client 205 as detected by pass-through unit 214 (initially detected address 219). Communication message 232 may instruct client 205 to send an acknowledgment response 233 directly to analysis unit 213.

At decision block 330, it is determined whether the analysis unit 213 received an acknowledgment response 233 from client 205. If so, the actual IP address information that analysis unit 213 detects is the public address and port that was assigned to the private address and port by NAT device 210. This actual IP address information that analysis unit 213 detects is designated as analysis-detected address 220.

At block 340, analysis unit 213 may compare inserted address 218, initially detected address 219, and analysis-detected address 220. This comparison may lead to the detection of the NAT type. There are two plausible options. At block 350, if the inserted address 218 equals the initially detected address 219 and the analysis-detected address 220, then client 205 is not behind a NAT device. At block 360, if the inserted address 218 is not equal to the initially detected address 219 and initially detected address 219 equals the analysis-detected address 220, then client 205 is behind a full cone NAT device.

Reference is now made to FIGS. 2B and 3B that demonstrate a further detection process according to embodiments of the present invention, in the event that analysis unit 213 does not receive an acknowledgement response 233 from client 205.

At block 370, analysis unit 213 may re-send communication message 232 as communication message 234 to client 205 via pass-through unit 214. At block 375, following the re-sending of communication request 234, analysis unit 213 may typically receive an acknowledgment response 235 from client 205. Analysis unit 213 may detect the IP address and port of client 205, hereinafter referred to as analysis-detected address 220. Acknowledgment response 235 may include the IP address and port of client 205, as embedded by client 205, referred to as inserted address 218.

At block 380, analysis unit 213 may compare inserted address 218, initially detected address 219, and analysis-detected address 220. If analysis-detected address 220 equals inserted address 218 that equals initially detected address 219, then client 205 is behind a symmetric UDP firewall (block 385). If analysis-detected address 220 does not equal inserted address 218 and analysis-detected address 220 equals initially detected address 219, then client 205 is behind a restricted or port restricted NAT device 210 (block 390). If analysis-detected address 220 does not equal inserted address 218 and analysis-detected address 220 does not equal initially detected address 219, then client 205 is behind a symmetric NAT device 210 (block 395).

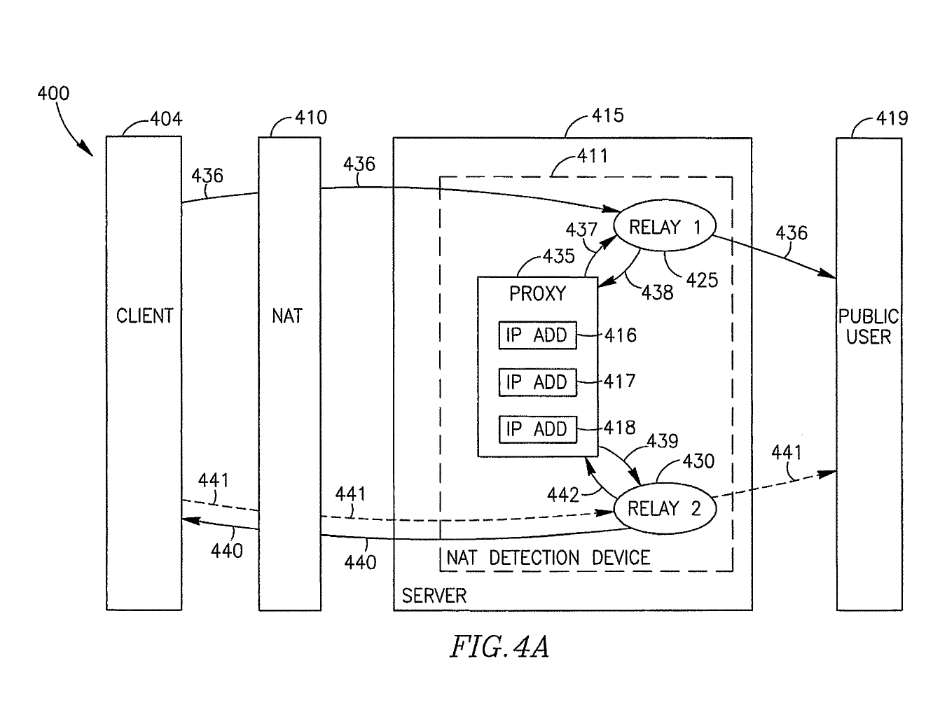

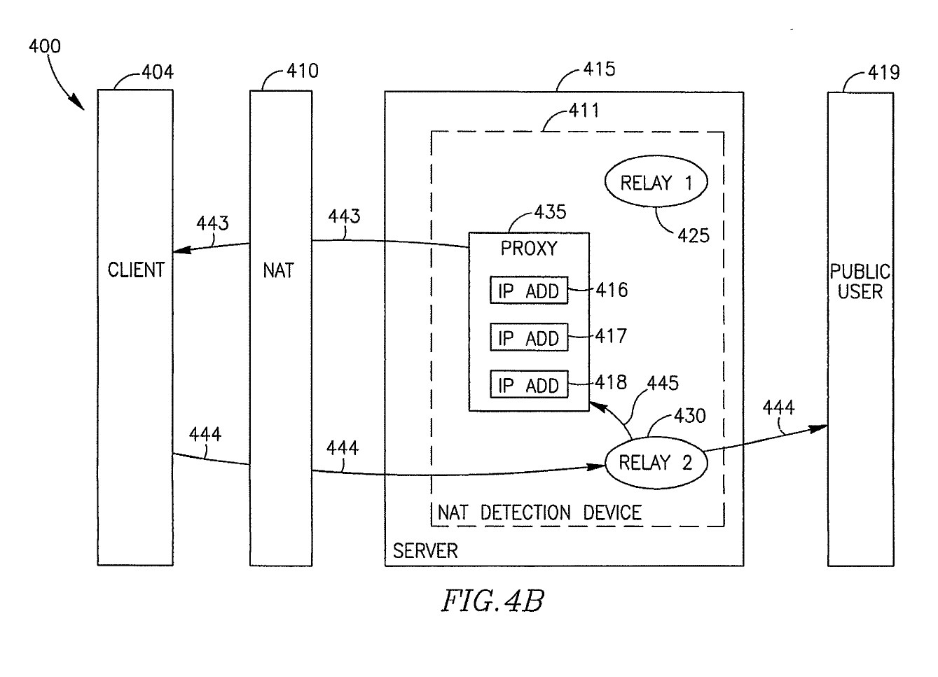

FIG. 4A is a block diagram of an exemplary network 400 that includes an active server-side NAT detection device according to some embodiments of the present invention. These embodiments may be suitable whenever the network, wishing to obtain the NAT status of a client 404, is not the first non-NAT hop. In these embodiments the discovery package protocol may be a media protocol, such as for example RTP. In the exemplary embodiments described below, it is assumed that the call is already set up and media is flowing through a media relay between both parties involved in the call However, it should be understood to those skilled in the art that embodiments of the present invention may be applicable to detecting the type of NAT device during call set up as well. In the exemplary embodiments described below, RTP media is being used as an example of media flow between end users. However, it should be understood to those skilled in the art that embodiments of the present invention may be applicable to other media flow as well.

Network 400 may comprise client (IP-based client device) 404 behind a NAT device 410, server 415, and a public user 419. Server 415 may comprise a server-side NAT detection device 411 having proxy unit 435, RTP-Relay1 unit 425, and RTP-Relay2 unit 430. Proxy unit 435 may transfer signaling messages between end users and may enable the establishment of the call. A stream of communication 436, for example RTP data packets or similar communication means thereof, may be flowing between client 404 and public user 419 via RTP-Relay1 425.

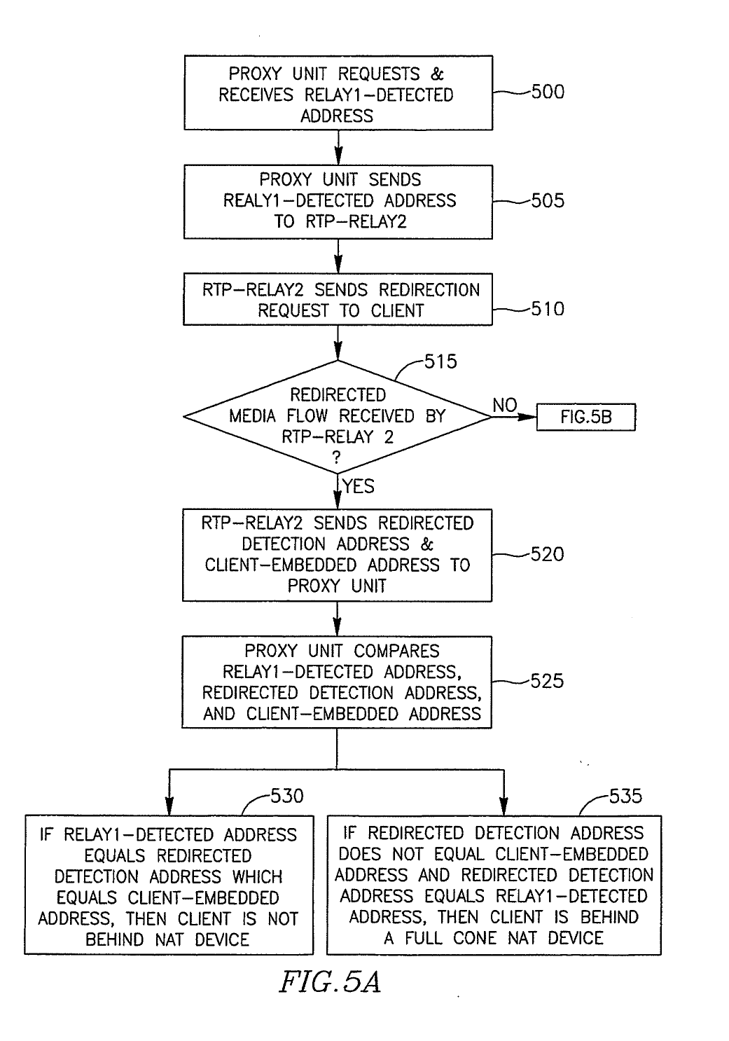

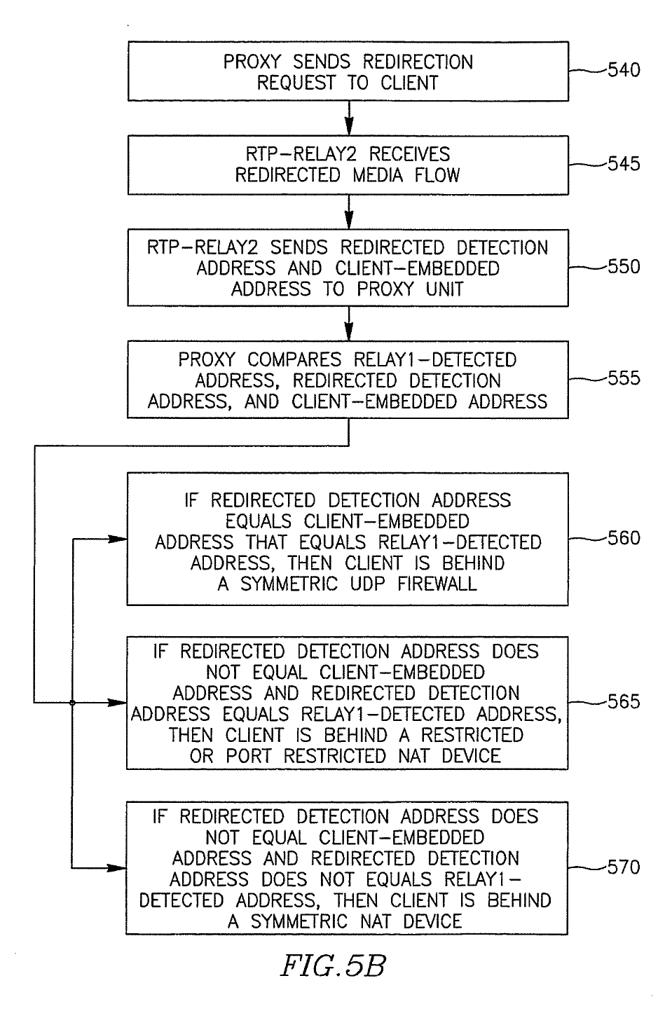

Additional reference is made to FIG. 5A, which is a flowchart diagram describing a method for actively detecting a type of NAT device to enable a two way communication with a client device located behind the NAT, according to embodiments of the present invention. The exemplary embodiment below describes an implementation for a media protocol.

At block 500, proxy unit 435 may typically send request 437 requesting the IP address and port of client 404, as detected by RTP-Relay1 425. Throughout the specification and claims, the detected IP address and port of client 404, as initially detected by RTP-Relay1 425, will be referred to as Relay1-detected address 416. Upon receiving media flow 438 embedded with Relay1-detected address 416, proxy 435 may embed Relay1-detected address 416 into a data packet and send media 439 to RTP-Relay2 430 (block 505). RTP-Relay2 430 may send a communication request 440 to client 404 in order to redirect the media flow 436, e.g. RTP or similar communication means, through RTP-Relay2 430 (block 510).

At decision block 515, a determination is made whether or not RTP-Relay2 unit 430 received redirected media flow 441 from client 404. RTP-Relay2 unit 430 may receive redirected media flow 441 from client 404, embedded with the client's internal IP address and port Throughout the specification and claims, the detected IP address and port of client 404, as detected by RTP-Relay2 430, will be referred to as redirected detection address 417. The IP address and port, as embedded by client 404 in redirected media flow 441, will be referred to as client-embedded address 418, hereinafter.

At block 520, RTP-Relay2 430 may typically send 442 both the redirected detection address 417 and client-embedded address 418 to proxy unit 435. According to the type of NAT device 410, redirected detection address 417 may be equal to or different than Relay1-detected address 416.

At block 525, proxy unit 435 may compare Relay1-detected address 416, redirected detection address 417, and client-embedded address 418. There may be at least two plausible options to determine the type of NAT or lack thereof. If Relay1-detected address 416 equals redirected detection address 417 which equals client-embedded address 418, then client 404 is not behind NAT device 410 (block 530). If redirected detection address 417 does not equal client-embedded address 418 and redirected detection address 417 equals Relay1-detected address 416, then client 205 is behind a full cone NAT device 210 (block 535).

Reference is now made to FIGS. 4B and 5B that demonstrate a further detection process according to embodiments of the present invention, in the event that media is not redirected 441 through RTP-Relay2 430.

At block 540, proxy 435 may send a redirection request 443, embedded with the IP address and port of RTP-Relay2 430, to client 404 in order for the media flow 436 to be redirected 444 through RTP-Relay2 430. At block 545, following the redirection request 443 to client 404, client 404 may redirect media flow 444 through RTP-Relay2 430. RTP-Relay2 unit 430 may receive redirected media flow 444 including the internal IP address and port of client 404, as embedded by client 404. The IP address and port detected by RTP-Relay2 430 will be referred to as redirected-detection address 417, hereinafter. The IP address and port, as embedded by client 404 will be referred to as client-embedded address 418, hereinafter RTP-Relay2 430 may typically send 445 redirected-detection address 417 and client-embedded address 418 to proxy unit 435 (block 550).

In block 555, proxy unit 435 may compare Relay1-detected address 416, redirected detection address 417, and client-embedded address 418. This comparison may determine NAT device 410 type. If redirected detection address 417 equals client-embedded detection address 418 that equals Relay1-detected address 416, then client 404 is behind a symmetric UDP firewall (block 560). If redirected detection address 417 does not equal client-embedded detection address 418 and redirected detection address 417 equals Relay1-detected address 416, then client 404 is behind a restricted or port restricted NAT device 210 (block 565). If redirected detection address 417 does not equal client-embedded detection address 418 and redirected detection address 417 does not equal Relay1-detected address 416, then client 404 is behind a symmetric NAT device 210 (block 570).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
determining in a server coupled to a public communication network the type of a network address translation (NAT) device, said NAT device is coupled to said server via a public communication network and to a client device via a private communication network, said client device is not required to be aware of the type of the NAT device.

2. The method of claim 1 comprising:
upon receiving a communication from any client device, determining whether the client device is located behind any NAT device.

3. The method of claim 1, wherein determining the type of said NAT device comprises:
comparing a first address information, a second address information and a third address information associated with said client device, said first address information is embedded by said client device in a communication request sent by said client device via said NAT device, said second address information is detected by a first signaling unit as the origin of said initial signaling communication request and said third address information is detected by a second signaling unit as the origin of a second signaling communication sent by said client device via said NAT device.

4. The method of claim 1, wherein determining the type of said NAT device comprises:
sending a request to a first media relay unit through which media flows from said client device to send a first address information associated with said client device, said first address information is detected by said first media relay unit as the origin of said media communication.
comparing the first address information, a second address information and a third address information associated with said client device, and said third address information is detected by a second media relay unit as the origin of a second media relay communication sent by said client device, wherein said second address information is embedded by said client device in a media communication sent by said client device.

5. The method of claim 3, wherein comparing the first address information, the second address information and a third address information comprising determining the type of said NAT device as a full symmetric type if the first address information, the second address information and a third address information are different from each other.

6. A passive server-side NAT detection device comprising:
a first signaling unit coupled to a public communication network to receive a signaling communication sent by a client device via a network address translation (NAT) device, said communication is being received directly from said NAT device; and
an analysis unit coupled to said first signaling unit and to said communication network to determine the type of the NAT device based on address information associated with said client device received from said first signaling unit and said analysis unit.

7. The system of claim 6, wherein said address information comprises a first client address information, said first client address information is embedded by said client device in a communication request sent by said client device via said NAT device, a second client address information, said second client address information is detected by said first signaling unit as the origin of an initial communication request and said third address information is detected by said analysis unit as the origin of a second communication sent by said client device via said NAT device.

8. The system of claim 6, wherein said first signaling unit is a SIP (Sessions Initiated Protocol) signaling server.

9. An active server-side NAT detection device comprising:
a first media server coupled to a public communication network to receive media communication from a client device via a network address translation (NAT) device;
a second media server coupled to said public communication network to receive media communication from said client device via said NAT device; and
a media proxy unit coupled to said first and to said second servers to determine the type of the NAT device based on address information associated with said client device received from said first and said second servers.

10. The device of claim 9, wherein said first and said second servers are real-time transport protocol (RTP) servers.

11. The system of claim 9, wherein said address information comprises a first client address information, said first client address information is embedded by said client device in a first media communication sent by said client device via said NAT device, a second client address information, said second client address information is detected by said first media server as the origin of said first media communication and said third address information is detected by said second media server as the origin of a second media communication sent by said client device via said NAT device.
